(19) United States
(12) Patent Application Publication
(10) Pub. No.: US 2017/0061459 A1
(43) Pub. Date: Mar. 2, 2017

(54) AUGMENTED REALITY SOLUTION FOR PRICE EVALUATION

(71) Applicant: International Business Machines Corporation, Armonk, NY (US)

(72) Inventors: Eli M. Dow, Wappingers Falls, NY (US); Erin M. Farr, Fishkill, NY (US); Moses J. Vaughan, Mahwah, NJ (US)

(21) Appl. No.: 14/841,774

(22) Filed: Sep. 1, 2015

(51) Int. Cl. G06Q 30/02; G06K 9/62; G06F 17/30; G06T 19/00

(52) U.S. Cl. CPC G06Q 30/0206; G06T 19/006; G06K 9/6202; G06F 17/3087; G06F 17/30867

(57) ABSTRACT

A method for presenting a formulated fair price range for a vehicle on a mobile computing platform in an augmented reality format. Embodiments of the present invention receive a digital image of a vehicle, identify distinguishing characteristics of the vehicle, cross reference those characteristics with multiple databases to identify the unique vehicle or vehicle type, retrieve from other databases data relating to the value of the vehicle or vehicle type and analyze and correlate the data to formulate a fair price range for the vehicle that is presented as a virtual image superimposed over the vehicle in the digital image. The data relating to vehicle value include crime data for a particular geographic area, crime data against different types of vehicles and geographic and environmental considerations such as climate and weather patterns or popularity and buying trends. A corresponding computer program product and computer system are also disclosed herein.

### BACKGROUND OF THE INVENTION

The present invention relates generally to the field of augmented reality, and more particularly to computing devices with augmented reality applications for vehicle price evaluation.

There are many factors which can influence the value of a vehicle, (e.g., cars, trucks or motorcycles, etc . . . ) whether they are being bought in new or used condition. These factors can include, for example, official ratings, reviews and reliability reports from a variety of publications and informative sources, social media or blog comments about a type of vehicle and, in the case of used vehicles, an accident history report and service and repair logs. With the rise of mobile computing technology today, applications are being developed which can help a potential buyer or seller of a vehicle gather all of this separate information pertaining to the value of the vehicle and use it to determine a fair and accurate price. Additionally, applications of this sort can be embodied in an augmented reality format where information in various forms can be overlaid or superimposed onto images of objects in a real-time streaming video, recorded video, or still pictures.

### SUMMARY

According to one embodiment of the present invention, a method for object price evaluation is provided, the method comprising receiving a digital image of one or more objects and one or more associated indicators; comparing the one or more associated indicators with a first one or more databases for identifying the one or more objects; retrieving data related to a price value of each of the one or more objects from a second one or more databases wherein the data comprises crime data and location data associated with the one or more objects; formulating a fair price range for each of the one or more objects based on an analysis and correlation of the data; and presenting at least one of the fair price range and at least a portion of the data as a virtual image superimposed over at least one of the object and the one or more associated indicators on a display screen of a computing device for each of the one or more objects. A corresponding computer program product and computer system are also disclosed herein.

### BRIEF DESCRIPTION OF THE DRAWINGS

FIGS. 1A-B is a functional block diagram illustrating a distributed data processing environment and a block diagram depicting process components of an object recognition application, respectively, in accordance with an embodiment of the present invention;

FIGS. 2A-B is an illustration of an environment and an illustration of a close-up view of a display screen of a computing device, respectively, in accordance with an embodiment of the present invention;

FIG. 3 is a flowchart depicting the operational steps of an object recognition application, in accordance with an embodiment of the present invention; and

FIG. 4 sets forth a generalized architecture of computing platforms suitable for at least one embodiment of the present invention.

### DETAILED DESCRIPTION

Embodiments of the present invention disclosed herein recognize that there are many factors that affect the value of a vehicle and that there is more data available than ever before which is relevant to vehicle value. Presently, a potential buyer or seller of a vehicle might be aware of some of these factors affecting the value, yet not have a streamlined solution to gather the separate data and information related to these factors from a wide variety of sources and compare them in one integrated platform to determine an accurate value for the vehicle of interest. With this in mind, embodiments of the present invention provide a means to utilize a mobile computing device to recognize a vehicle in a real-time video stream, gather information relevant to the value of the vehicle (or vehicle type such as class, make, model, year of manufacture, color, etc . . . ) and correlate and analyze the information to formulate and present a fair and reasonable price range that can be expected for the vehicle in an augmented reality (AR) format, which can be beneficial in price negotiations for both a buyer and a seller.

A number of categories of information related to vehicle value exist that are associated with particular vehicles or vehicle types. These categories of information can include, but are not limited to, unique vehicle history (e.g., maintenance history, accident history, ownership record, etc . . . ), vehicle type popularity (including social media data, online blog posts and national or local popularity trends), vehicle pricing information (from manufacturers, local dealerships, classified advertisements, etc . . . ), cost of ownership (e.g., fuel efficiency, anticipated maintenance and repairs, etc . . . ), vehicle recall information and official vehicle reviews, ratings and reliability reports from reputable sources and publications. It is also noteworthy that certain vehicles, depending on where they were originally delivered to for sale after manufacture, may have certain functional features built-in that other vehicles of the same type do not. These features can include, for example, tinted windows, better radiators and external fluid coolers in vehicles intended for use in a hotter climate and larger batteries and engine block heaters in cars intended for colder climates. These and other similar features, if included in a used car for sale, can be further pricing considerations depending on whether or not they are perceived as desirable and/or necessary by a buyer.

What has not previously been taken into consideration are external factors that may not directly pertain to a vehicle (or vehicle type) but can influence the value of the vehicle nonetheless. It should be noted that these external factors can be a function of geographic location, wherein some examples include, but are not limited to, environmental factors (such as climate, weather data, weather trends and historical weather statistics for a geographic region), the setting of the geographic region (e.g., an urban setting, rural setting, etc . . . ) and crime data comprising crime rates, trends and statistics for a geographic location. Some of this crime data can also include the history of theft against a vehicle type or the previous involvement of a particular vehicle in any crime-related activity. It should be further noted that data or information related to the climate, weather or setting of a geographic location can be referred to as “location data” and this can also include vehicle buying trends or popularity trends for a geographic location.

One example of how these external factors influence vehicle value is that they can be insurance considerations and therefore affect the monthly rates associated with insuring a vehicle in a certain geographic location, which is something that can be considered by embodiments of the present invention during computational processes, as will be discussed subsequently.

Combining all of this data and information affecting vehicle value, including data pertaining to the previously mentioned external factors, provides a comprehensive and specific picture of the true value of a vehicle that can be used by embodiments of the present invention to formulate (i.e., generate) an accurate and fair price range. As an illustrative example, a car that has been driven for four years in a very cold and snowy climate (where salt is frequently present on the roads for better traction) is more likely to rust, regardless of where it is being sold after those four years, than if the same car had been driven for the four years in a typically hot and dry climate. These kinds of considerations, amongst others, can be used by embodiments in conjunction with other factors and data (vehicle mileage being one example) to arrive at an accurate picture of vehicle value.

For illustrative purposes, a non-exhaustive list of vehicles that can be recognized by embodiments of the present invention can include cars, trucks, SUVs, ATVs, motorcycles, boats, planes and helicopters. Although the disclosure provided herein primarily refers to the use of embodiments as they pertain to vehicles, other embodiments can be used to generate fair prices ranges for objects other than vehicles as well, which will be discussed in greater detail subsequently.

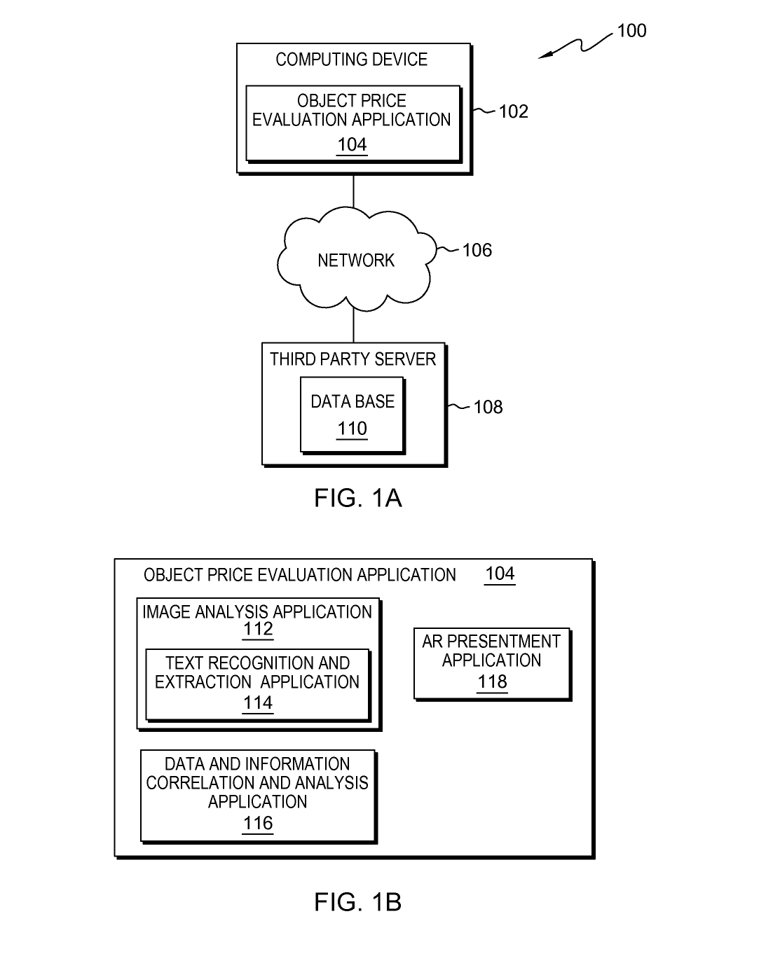

The present invention will now be described in detail with reference to the figures. FIG. 1 is a functional block diagram illustrating a distributed data processing environment 100, in accordance with one embodiment of the present invention. Distributed data processing environment 100 includes computing device 102 and one or more third party servers 108, all interconnected over network 106. Computing device 102 can be a smart phone, a tablet computer, a laptop computer, a personal digital assistant (PDA), a wearable computing device (e.g., a smart watch) or any programmable electronic device capable or communicating with one or more third party servers 108 via network 106. Computing device 102 includes object price evaluation application 104 operational to access one or more third party servers 108, which can include one or more databases 110, to recognize the vehicle of interest and retrieve vehicle related data and information for correlation and analysis for the formulation of a fair price range.

Some examples of third party servers 108 and databases 110 can include, but are not limited to, a Department of Motor Vehicles (DMV) database, a vehicle identification number (VIN) database, a license plate number database, CARFAX, Kelly Blue Book, NADAGUIDES, Consumer Reports, a classified advertisements website (e.g., Craigslist), a social media website (e.g., Facebook, Twitter, etc . . . ) a weather website (e.g., Weather.com) and local municipal or governmental databases providing information about a particular geographic location (e.g., crime data, weather and climate data and other geographic, topographic or demographic information). It should be noted that any of these databases 110 can be websites and can also include social media sentiment analysis websites (e.g., for information about overall opinions of a make and model of a vehicle) and a VIN decoder website.

Network 106 can be, for example, a local area network (LAN), a wide area network (WAN) such as the Internet, or a combination of the two, and include wired, wireless, or fiber optic connections. In general, network 106 can be any combination of connections and protocols that will support communications between computing device 102 and third party server 108, in accordance with a desired embodiment of the present invention.

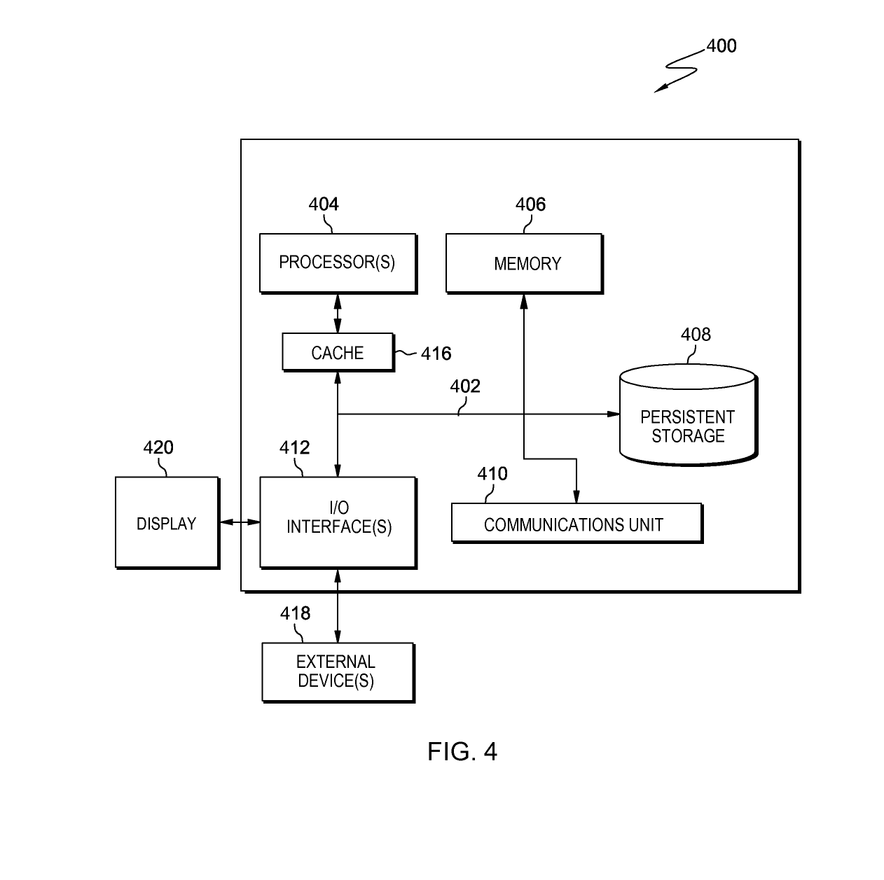

Computing device 102 can include internal and external hardware components, as depicted and described in further detail with respect to FIG. 4. Furthermore, it should be understood that distributed data processing environment 100 can in some embodiments include a remote server computer (not shown), connected to computing device 102 and one or more third party servers 108 via network 106, having object price evaluation application 104 installed to handle the logical processes of the present invention and output the results to computing device 102.

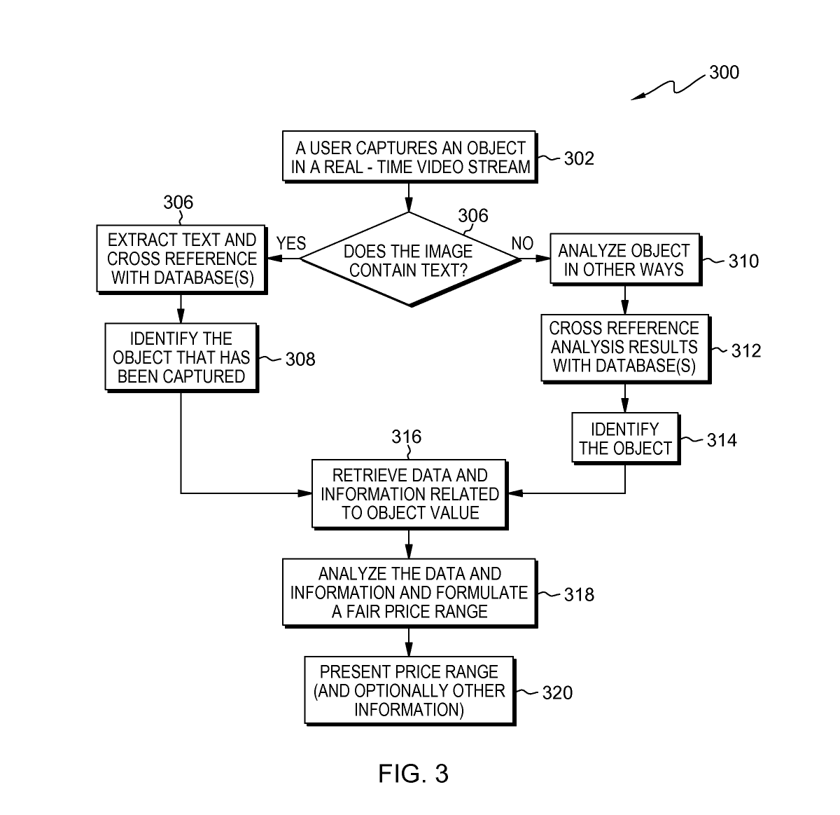

FIG. 1B is a block diagram of object price evaluation application 104 containing associated component applications according to an embodiment of the present invention. Image Analysis Application 112 can analyze digital images of objects captured in a real-time video stream as will be discussed subsequently so that those objects can be identified. Image Analysis Application 112 contains Text Recognition and Extraction Application 114 to recognize and extract any alphanumeric text present on a digital image in a real-time video stream for identifying the object associated with the digital image. Data and Information Correlation and Analysis Application 116 provides the computational processes embodied by the present invention for determining a fair price range for the identified object. AR Presentment Application 118 provides the capability to superimpose information, including the formulated fair price range, about identified objects over their associated digital images on the screen of a computing device. Further details of the operation of these component applications of object price evaluation application 104 with regard to the implementation of embodiments will be further described and discussed subsequently in FIG. 3.

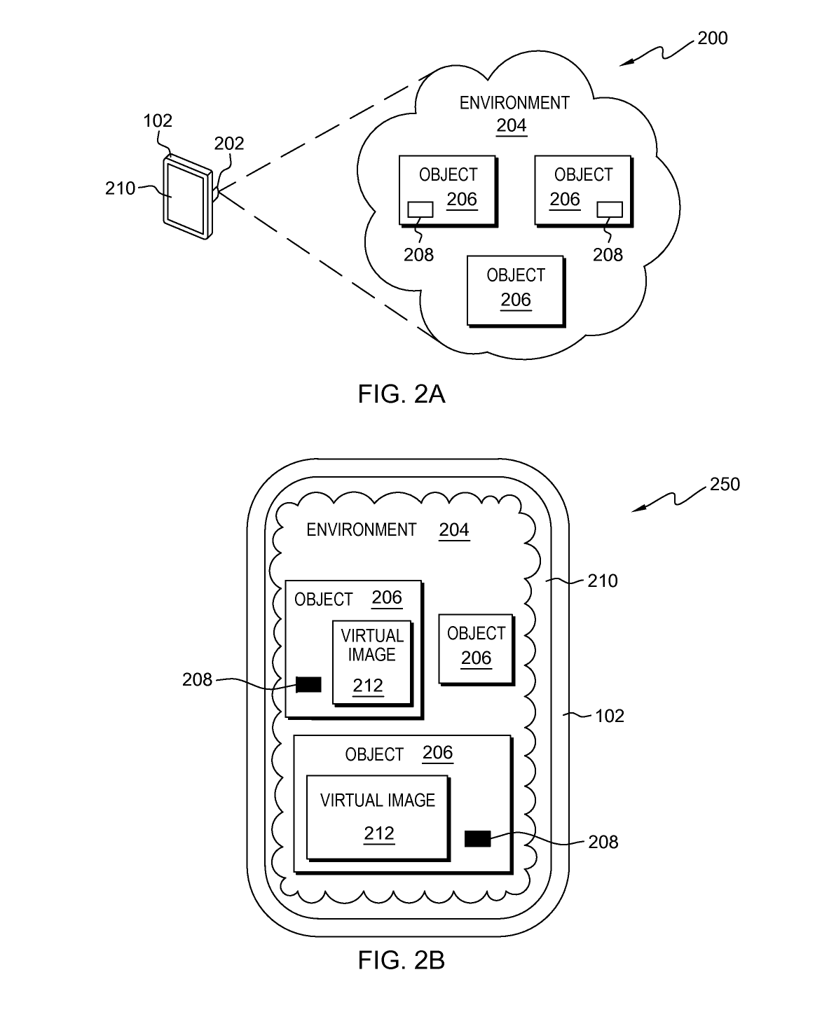

FIG. 2A depicts an environment 200 wherein a user (not shown) of a computing device 102 with display screen 210 is using an integrated camera 202 to capture a live video stream of an environment 204 which includes one or more objects 206 having one or more associated indicators 208. Embodiments of the present invention use indicators 208 to recognize (i.e., identify) the one or more objects 206 and retrieve information associated with them to formulate and present a fair price range for the one or more objects 206. Some examples of indicators 208 can include, but are not limited to, a VIN, a license plate number, a vehicle registration card, any alphanumeric text, a stylistic feature of a portion of an exterior of a vehicle or a portion of an interior of a vehicle, one or more facial features, one or more aspect ratios and/or one or more particular colors. It should also be noted that although the disclosure provided herein refers primarily to embodiments of the present invention employing a real-time video stream, other embodiments can be configured to analyze a previously recorded video or a still digital picture that may have previously been taken.

FIG. 2B presents a close-up view 250 of display screen 210 on computing device 102 operating object price evaluation application 104, in accordance with an embodiment of the present invention. The digital image of environment 204 on display screen 210 contains digital images of objects 206 and associated indicators 208 and, subsequent to the logical processes executed by embodiments of the present invention, one or more generated virtual images 212 superimposed on the digital images of objects 206 and/or indicators 208 on display screen 210 in an augmented reality (AR) format. Virtual images 212 can be information about the vehicle, such as, but not limited to, year of manufacture, make, model, mileage, accident and maintenance information, ratings, reviews, social media comments (such as tweets), consolidated crime data information, prices from third party sources (filtered for a local area) and/or a fair price range formulated by the analysis of this information by embodiments of the present invention.

It should be understood that some embodiments of the present invention can allow for the digital images of one or more captured indicators 208 to be saved or stored in local memory of the computing device 102 for future reference and use by object price evaluation application 104, as will be described subsequently.

Some other examples of items that can be formulated (i.e., generated) by embodiments of the present invention and presented as virtual images 212 are a relative risk metric (e.g., a risk percentage or a value on a scale from lowest to highest risk) associated with owning a certain vehicle or type of vehicle in a particular geographic location (according to the correlation and analysis of information and data pertaining to the external factors that can influence vehicle value), or similar vehicle recommendations available in a local geographic region.

In some embodiments of the present invention, virtual images 212 can be transparent alphanumeric text or images (the transparency of which can optionally be user-adjusted), solid alphanumeric text or images or any combination thereof and can include hyperlinks that open a webpage in a separate web browser when selected or clicked. It should be further noted that although the disclosure provided herein refers primarily to information associated with the objects 206 and/or a generated price range being presented as virtual images 212 in an AR format, these can also be presented in other ways, such as in a separate window that opens wherein all or some of the information retrieved or generated is displayed as text on a generic (i.e., blank) background, as one example.

Turning to FIG. 3, a flowchart 300 of the logical processes executed by at least one embodiment of the present invention is depicted. Starting at block 302, object price evaluation application 104 on computing device 102 captures an object 206 with one or more associated indicators 208 in a real-time video stream and then at decision block 304 it is decided if any text is present on the object 206. If text is detected, it is extracted and cross-referenced with one or more databases 110 (e.g., VIN database, license plate number database, etc . . . ) at block 306 so object 206, captured in block 302, can be identified at block 308. Once object 206 has been identified, data and information pertaining to object 206 (which can include its current geographic location) and to its value are retrieved at block 316 from a variety of sources and databases 110 as previously discussed, according to a predetermined (and optionally user-set) criteria. If the current geographic location of object 206 can be retrieved, the step at block 316 can be repeated to retrieve data and information pertaining to the external factors associated with that geographic location from other databases 110. Optionally, according to some embodiments, if no data or information pertaining to the geographic location of object 206 can be retrieved, a user can receive a prompt (i.e., a pop-up notification) on display screen 210 to manually enter the geographic location of interest (e.g., a state, a city, an address, a zip code, etc . . . ) for the retrieval of data and information pertaining to external factors associated with that location.

Embodiments of the present invention, at block 318, correlate and analyze the retrieved data and information to formulate a fair price range for object 206. Next, at block 320, embodiments utilize AR Presentment Application 118 to present the fair price range (and optionally other retrieved information associated with object 206) on display screen 210 as a virtual image 212 in an AR format as previously described.

If text is not detected at decision block 304 then embodiments analyze the digital image of object 206 and one more associated indicators 208 at block 310 in other ways (e.g., identify aspect ratios, colors or other distinguishing aesthetic, non-textual features such as vehicle body style, vehicle dashboard and interior console design, etc . . . ) and cross reference the analysis results with one or more databases 110 at block 312 to identify object 206 at block 314. Next, embodiments retrieve data and information associated with object 206 at block 316, analyze and correlate, at block 318, the data and information and formulate a fair price range for presentation at block 320 as previously described.

The logical processes executed at blocks 306 and 310 relate to the analysis of the digital image of object 206 being captured in a real-time video stream and are handled by Image Analysis Application 112 and Text Recognition and Extraction Application 114. According to embodiments, these component applications of object price evaluation application 104 can utilize suitable pattern recognition algorithms to recognize one or more associated indicators 208 on the digital image of captured object 206 and compare these indicators 208 with those stored in databases 110 or those previously captured and stored in local memory on the computing device 102 from past instances of use of object price evaluation application 104.

According to embodiments, the formulation of a fair price range at block 318 can be accomplished by algorithms, executed by Data and Information Correlation and Analysis Application 116, that weigh and correlate all of the relevant data and information retrieved at block 316 and perform statistical computations to generate an adjusted, fair and reasonable price range for a vehicle of interest in a particular geographic location. A user can choose to preconfigure which factors and data they consider the most important and relevant to vehicle value which will therefore have the most statistical weight during these computations. For example, a user may decide that the history of theft against the color of the vehicle of interest is an important factor which should have greater weight during price range adjustment and formulation.

As an illustrative example according to one embodiment, average price values for a vehicle can be computed using prices and price ranges retrieved from third party sources, such as, but not limited to, local dealerships, local auctions and/or local private listings (from a classified advertisements website) for similar vehicles that can be either new or used. The computed averages can be adjusted by retrieved data pertaining to reviews and reliability reports, social media sentiment analysis or estimated insurance costs associated with insuring the vehicle for a particular area (which can be based on the data and information pertaining to the external factors specific to the area, such as weather and crime data, etc . . . ) or any combination thereof. Adjustments to the computed price range averages could, for example, reflect the fact that a certain vehicle may be more costly to own in the long term because of anticipated repairs and maintenance costs, which can be correlated with the current vehicle mileage and local climate data, or because of high estimated insurance costs associated with insuring the vehicle in its current geographical area due to the likelihood of theft against it and these considerations can be used in combination. Adjustments made will also consider the choices made by the user as to which data should have the most weight.

It should further be noted that embodiments of the present invention can also allow for a user to manually enter textual information (such as a VIN number or license plate number) in object price evaluation application 104 to begin the logical processes executed by the embodiment.

Some examples of objects other than vehicles that can be identified by various embodiments of the present invention can include, but are not limited to, houses (e.g., a house can be identified by a user capturing the address as text or a portion of the interior or exterior of the house in a real-time video stream), buildings, the geographic location of environment 204, or a person (e.g., a user captures a real-time video stream of someone's face to be identified). An example implementation wherein a person is identified by an embodiment could be that an employer captures the person's face in a real-time video stream to determine a fair and/or reasonable salary range for them (for example, once they are identified, their public information posted online, such as a resume or LinkedIn profile, could be used by an embodiment to formulate a reasonable salary range for them based on their experience level and qualifications) if they are being considered for hiring. The above examples are intended to be illustrative but not restrictive with regard to how embodiments of the present invention can be variously implemented and employed by one skilled in the art.

FIG. 4 depicts a block diagram of components of computing device 102 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 102 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Object price evaluation application 104 can be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Object price evaluation application 104 may be downloaded to persistent storage 408 through communications unit 410.

I/O interface(s) 412 allows for input and output of data with other devices that may be connected to computing device 102. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., object price evaluation application 104, can be stored on such portable computer readable storage media and can be loaded onto persistent storage 408 via I/O interface(s) 412. I/O interface(s) 412 also connect to a display 420.

Display 420 provides a mechanism to display data to a user and can be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for object price evaluation, the method comprising:
receiving a digital image of one or more objects and one or more associated indicators;
comparing the one or more associated indicators with a first one or more databases for identifying the one or more objects;
retrieving data related to a price value of each of the one or more objects from a second one or more databases wherein the data comprises crime data and location data associated with the one or more objects;
formulating a fair price range for each of the one or more objects based on an analysis and correlation of the data; and
presenting at least one of the fair price range and at least a portion of the data as a virtual image superimposed over at least one of the object and the one or more associated indicators on a display screen of a computing device for each of the one or more objects.

2. The method of claim 1, wherein the one or more objects comprise at least one of a car, a truck, a van, an SUV, a motorcycle, an ATV, a boat, a plane, a helicopter, a house, a building and a person.

3. The method of claim 1, wherein the one or more associated indicators comprise at least one of a vehicle identification number, a license plate number, a vehicle registration card, alphanumeric text, an address, at least a portion of the object, one or more facial features and one or more colors.

4. The method of claim 1, wherein the first one or more databases and the second one or more databases each comprise at least one of a vehicle identification number database, a license plate number database, a vehicle registration database, a social media website, a web blog, an online vehicle rating, an online vehicle review, an online vehicle reliability report, an online vehicle history and accident report, a weather database, a municipal database and a government database.

5. The method of claim 1, wherein the data is associated with a vehicle and the vehicle's location and further comprises at least one of year of vehicle manufacture, vehicle make, vehicle model, vehicle accident information, built-in functional features, vehicle maintenance history, vehicle ratings, vehicle reviews, vehicle reliability reports, vehicle fuel efficiency, social media comments, and blog comments.

6. The method of claim 1, wherein the correlation and analysis is based on a preconfigured choice of which of the data is most relevant to vehicle value.

7. The method of claim 1, wherein the digital image is received from a group consisting of a real-time video stream, a recorded video and a still digital picture.

8. A computer program product for object price evaluation, the computer program product comprising:
one or more computer readable storage media and program instructions stored on the one or more computer readable storage media, the program instructions comprising:
program instructions to receive a digital image of one or more objects and one or more associated indicators;
program instructions to compare the one or more associated indicators with a first one or more databases for identifying the one or more objects;
program instructions to retrieve data related to a price value of each of the one or more objects from a second one or more databases wherein the data comprises crime data and location data associated with the one or more objects;
program instructions to formulate a fair price range for each of the one or more objects based on an analysis and correlation of the data; and
program instructions to present at least one of the fair price range and at least a portion of the data as a virtual image superimposed over at least one of the object and the one or more associated indicators on a display screen of a computing device for each of the one or more objects.

9. The computer program product of claim 8, wherein the one or more objects comprise at least one of a car, a truck, a van, an SUV, a motorcycle, an ATV, a boat, a plane, a helicopter, a house, a building and a person.

10. The computer program product of claim 8, wherein the one or more associated indicators comprise at least one of a vehicle identification number, a license plate number, a vehicle registration card, alphanumeric text, an address, at least a portion of the object, one or more facial features and one or more colors.

11. The computer program product of claim 8, wherein the first one or more databases and the second one or more databases each comprise at least one of a vehicle identification number database, a license plate number database, a vehicle registration database, a social media website, a web blog, an online vehicle rating, an online vehicle review, an online vehicle reliability report, an online vehicle history and accident report, a weather database, a municipal database and a government database.

12. The computer program product of claim 8, wherein the data is associated with a vehicle and the vehicle's location and further comprises at least one of year of vehicle manufacture, vehicle make, vehicle model, vehicle accident information, built-in functional features, vehicle maintenance history, vehicle ratings, vehicle reviews, vehicle reliability reports, vehicle fuel efficiency, social media comments, and blog comments.

13. The computer program product of claim 8, wherein the correlation and analysis is based on a preconfigured choice of which of the data is most relevant to vehicle value.

14. The computer program product of claim 8, wherein the digital image is received from a group consisting of a real-time video stream, a recorded video and a still digital picture.

15. A computer system for object price evaluation, the computer system comprising:
one or more computer processors;
one or more computer readable storage media;
program instructions stored on the one or more computer readable storage media for execution by at least one of the one or more processors, the program instructions comprising:
program instructions to receive a digital image of one or more objects and one or more associated indicators;
program instructions to compare the one or more associated indicators with a first one or more databases for identifying the one or more objects;
program instructions to retrieve data related to a price value of each of the one or more objects from a second one or more databases wherein the data comprises crime data and location data associated with the one or more objects;
program instructions to formulate a fair price range for each of the one or more objects based on an analysis and correlation of the data; and
program instructions to present at least one of the fair price range and at least a portion of the data as a virtual image superimposed over at least one of the object and the one or more associated indicators on a display screen of a computing device for each of the one or more objects.

16. The computer system of claim 15, wherein the one or more objects comprise at least one of a car, a truck, a van, an SUV, a motorcycle, an ATV, a boat, a plane, a helicopter, a house, a building and a person.

17. The computer system of claim 15, wherein the one or more associated indicators comprise at least one of a vehicle identification number, a license plate number, a vehicle registration card, alphanumeric text, an address, at least a portion of the object, one or more facial features and one or more colors.

18. The computer system of claim 15, wherein the first one or more databases and the second one or more databases each comprise at least one of a vehicle identification number database, a license plate number database, a vehicle registration database, a social media website, a web blog, an online vehicle rating, an online vehicle review, an online vehicle reliability report, an online vehicle history and accident report, a weather database, a municipal database and a government database.

19. The computer system of claim 15, wherein the data is associated with a vehicle and the vehicle's location and further comprises at least one of year of vehicle manufacture, vehicle make, vehicle model, vehicle accident information, built-in functional features, vehicle maintenance history, vehicle ratings, vehicle reviews, vehicle reliability reports, vehicle fuel efficiency, social media comments, and blog comments.

20. The computer system of claim 15, wherein the correlation and analysis is based on a preconfigured choice of which of the data is most relevant to vehicle value.
